(19) United States
(12) Patent Application Publication
(10) Pub. No.: US 2017/0293024 A1
(43) Pub. Date: Oct. 12, 2017

(54) COGNITIVE TRANSMISSION SWITCHING

(71) Applicant: GM Global Technology Operations LLC, Detroit, MI (US)

(72) Inventors: Shahar Villeval, Tel Aviv (IL); Igal Bilik, Rehovot (IL); Joseph Tabrikian, Tel Aviv (IL)

(21) Appl. No.: 15/092,759

(22) Filed: Apr. 7, 2016

(51) Int. Cl. G01S 13/52; G08G 1/16; G01S 13/86; G01S 13/72; G01S 13/58

(52) U.S. Cl. CPC G01S 13/52; G01S 13/72; G01S 13/58; G01S 13/865; G01S 13/867; G08G 1/166; G01S 2013/0236

(57) ABSTRACT

A cognitive transmission switching array radar system to determine a location of a target and method of performing cognitive transmission switching with an array radar system involve N transmit antenna elements. Aspects include obtaining a crude estimation for the location of the target, and selecting M channels for transmission based on the crude estimation, the M channels corresponding with a subset of the N transmit antenna elements. Processing reflections resulting from the M channels is done to determine the location of the target.

### FIELD OF THE INVENTION

The subject invention relates to cognitive transmission switching in an array radar system.

### BACKGROUND

An array radar system may have a multi-input multi-output (MIMO) configuration that uses multiple transmit antennas and multiple receive antennas or a multiple-input single-output (MISO) configuration that uses multiple transmit antennas and a single receive antenna. The one or more receive antennas of MIMO and MISO array radar systems receive reflections resulting from every transmitter. With N transmitters and K receivers (N+K total elements) in a MIMO configuration, for example, the array radar system has a virtual field of view of N*K elements. Because resolution increases with antenna size, the increase in virtual field of view results in an increase in the spatial resolution and angular resolution. However, in order to realize the increased resolution, the transmission associated with each reflection at each of the one or more receivers must be distinguishable. That is, because each of the one or more receivers receives reflections resulting from every transmitter, separability of the received signals is necessary to correctly process the reflections. An approach to being able to distinguish the transmissions of the multiple transmitters involves the use of time division multiplexing (TDM). According to TDM, each transmitter transmits in turn (at a different time delay). While the particular time delay associated with each transmitter facilitates distinguishing the reflection resulting from each transmitter, the TDM scheme imposes a required delay between transmissions (observation interval) from the same transmitter. That is, until each transmitter has transmitted, in turn, no transmitter may transmit again. When the MIMO or MISO array radar system is used as a Doppler radar, the maximum observable target velocity decreases as observation interval increases. Thus, the TDM scheme results in a decrease in maximum observable target velocity.

Accordingly, it is desirable to provide an array radar system that does not suffer from a decrease in maximum observable target velocity.

### SUMMARY OF THE INVENTION

According to an embodiment, a method of performing cognitive transmission switching with an array radar system including N transmit antenna elements to determine a location of a target includes obtaining a crude estimation for the location of the target; selecting M channels for transmission based on the crude estimation, wherein the M channels correspond with a subset of the N transmit antenna elements; and processing reflections resulting from the M channels to determine the location of the target.

According to another embodiment, a cognitive transmission switching array radar system to determine a location of a target includes N transmit antenna elements arranged in an array; and a processor configured to obtain a crude estimate for the location of the target, select M channels for transmission based on the crude estimation, the M channels corresponding with a subset of the N transmit antenna elements, and process reflections resulting from the M channels to determine the location of the target.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 shows an exemplary platform for the cognitive transmission switching array radar system according to embodiments;

FIG. 2 is a block diagrams of transmit and receive portions of the array radar system according to one embodiment;

FIG. 3 is a block diagrams of transmit and receive portions of the array radar system according to another embodiment; and

FIG. 4 is a process flow of a method of performing cognitive transmission switching in an array radar system according to embodiments.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

As noted above, an array radar system may be used for increased angular resolution. For a given desired angular resolution ΔΩ (generally expressed in steradians) with spacing α between antenna elements (expressed in terms of wavelength), the number of transmit antenna elements N or channels needed is given by:

$$N = \frac{1}{{α}^{2} Δ Ω} \qquad [ EQ . 1 ]$$

As also noted above, employing a time division transmission scheme in a conventional MIMO or MISO array radar system may result in a decrease in the maximum observable target velocity. This is because, according to EQ. 1 above, a large number of transmitter elements must transmit in order to obtain a given angular resolution, but, according to the time division transmission scheme, the large number of transmitter elements results in increased observation interval (time between transmissions by the same transmitter). The required number of transmit antenna elements N generally depends on the desired field of view (FOV)Ω_{fov} and angular resolution ΔΩ (generally expressed in steradians). The number of receive antenna elements may be one or more and may be, but is not required to be, the same number as the number of transmit antenna elements. The theoretical minimum number of antenna elements (transmit channels) N is given by the number of beams within the FOV as:

$${N}_{min} = \frac{{Ω}_{fov}}{Δ Ω} \qquad [ EQ . 2 ]$$

Using the theoretical minimum number according to EQ. 2 reduces the number of required elements. Embodiments detailed herein relate to cognitive transmission switching in an array radar system to maintain the maximum observable target velocity by reducing the observation interval while also maintaining angular resolution by reducing the FOV. As detailed below, only subsets of transmitter elements of the entire array radar are used, thereby reducing the observation interval for each transmission element as compared with using the time division transmission scheme for every transmission element of the MIMO radar system. Angular resolution is addressed according to one or more embodiments based on the cognitive aspect of the switching. That is, the FOV is reduced by determining or otherwise knowing an area of interest for the radar detection within the larger FOV of the array radar system. As such, EQ. 2 may be used to determine the number of transmitter elements needed to achieve a desired angular resolution within the smaller FOV. For example, according to EQ. 1, a 2 degree-by-2 degree resolution with a spacing α between elements given by 0.5<α<0.8 requires on the order of 2000 antenna elements (N=2000 according to EQ. 1), but the same resolution within a 60 degree-by-10 degree FOV requires on the order of only 150 antenna elements (Nₘᵢₙ=150 according to EQ. 2). The reduction in the number of required antenna elements for the same angular resolution results in a corresponding reduction in observation interval. Thus, maximum observable target velocity according to the embodiments is increased.

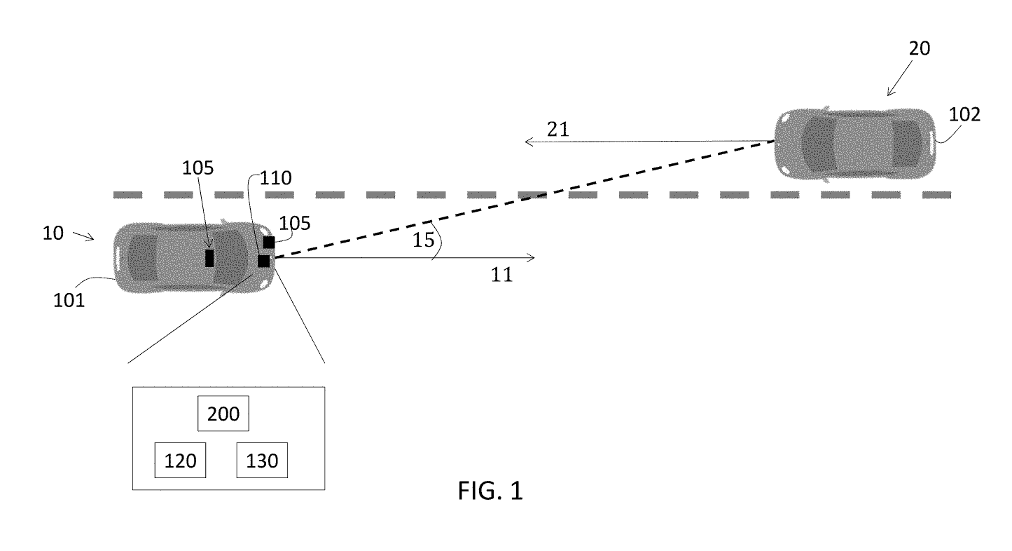

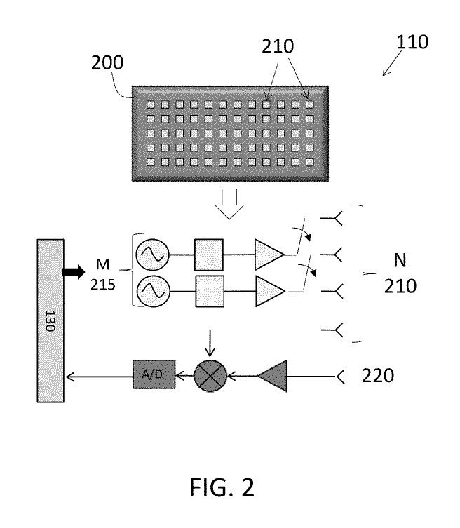

FIG. 1 shows an exemplary platform 10 for the cognitive transmission switching array radar system 110 according to embodiments. In FIG. 1, the platform 10 is a host vehicle 101, and the target 20 is another vehicle 102. The target 20 may also be a platform 10 for the array radar system 110. According to alternate or additional embodiments, the platform 10 may be a different type of vehicle or different type of system altogether (e.g., construction equipment, farm equipment, airborne or seaborne platform). In the exemplary arrangement shown in FIG. 1, the platform 10 and target 20 are travelling toward each other with velocities 11 and 21, respectively. The target 20 is at an angle 15 from the direction of travel of the platform 10. As FIG. 1 indicates, the array radar system 110 includes a transmit antenna element array 200, which is detailed in FIG. 2, one or more memory devices 120, and one or more processors 130. The memory device 120 stores instructions used by the processor 130 to process information from the array radar 200. The processor 130 controls the transmit antenna element array 200 to select which channels to operate in each cycle, as detailed below. The array radar system 110 may additionally include other known components such as input and output interfaces and communication devices to communicate with a central controller of the platform 10 and other sensors 105 of the host vehicle 101, for example. Other sensors 105 may be known sensors and include a lidar system or camera coupled with an image processor, for example.

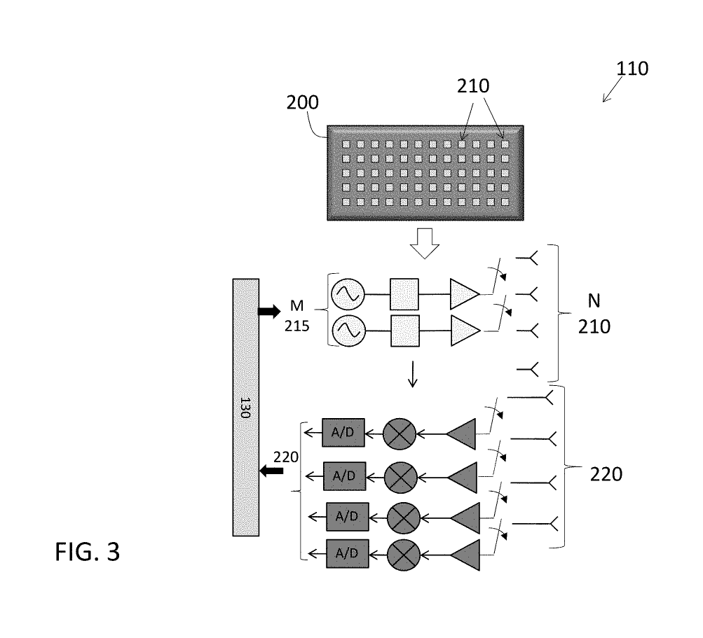

FIGS. 2 and 3 are block diagrams of transmit and receive portions of the array radar system 110 according to two different embodiments. The transmit antenna element array 200 includes N transmit antenna elements 210 and is the same in both FIG. 2 and FIG. 3. The array radar system 110 may include a single receive antenna element 220 in a MISO configuration, as shown in FIG. 2. The array radar system 110 may instead include an array of receive antenna elements 220, like the transmit antenna element array 200, in a MIMO configuration, as shown in FIG. 3. As FIGS. 2 and 3 indicate, a number M 215 of the transmit antenna elements 210 are used in a given cycle, where M 215 is less than N, the total number of transmit antenna elements 210. The processor 130 selects the value of M 215 and the particular ones of the transmit antenna elements 210 of the transmit antenna element array 200 that make up the M 215 transmit antenna elements 210 that transmit in a given cycle. As shown in FIG. 3, even when only M 215 transmit antenna elements 210 are used in a given cycle, all of the receive antenna elements 220 receive reflections resulting from all of the M 215 transmissions. As noted above and detailed below, the particular elements that are the M 215 channels used in a given cycle are selected by the processor 130. Further, the value of M 215 may differ from one transmission cycle to the next. Multiple transmission cycles are generally used to determine the location of a target 20.

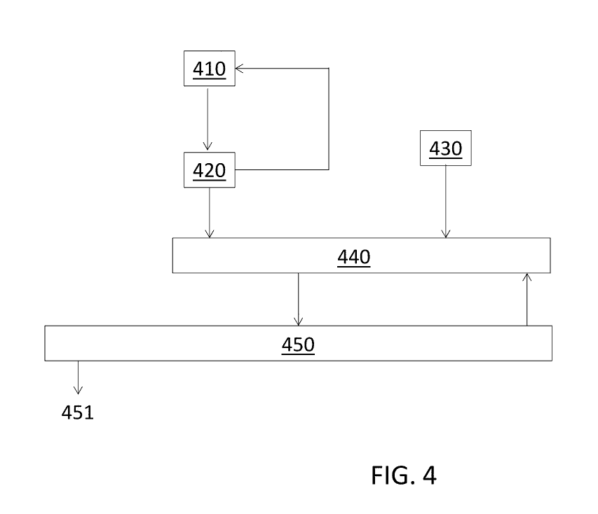

FIG. 4 is a process flow of a method of performing cognitive transmission switching in an array radar system 110 according to embodiments. At block 410, selecting a subset of antenna elements is done by the processor 130 and includes selecting the value of M 215 as well as which of the N transmit antenna elements 210 make up the M 215 channels. Processing received reflections to estimate the target 20 location, at block 420, may provide a crude estimate of the target 20 location. The processes at blocks 410 and 420 may be done iteratively, as indicated. The initial selection of the M 215 transmit antenna elements 210 may be according to a uniform linear array (ULA) arrangement, for example. According to alternative or additional embodiments, the processes may include the array radar system 110 obtaining information from another sensor 105 to determine a crude estimate of the target 20 location, at block 430. Once a crude estimate of the location of the target 20 is obtained, the processes include cognitively selecting a subset of transmit antenna elements 210, at block 440. The processor 130 may select the value of the number M 215 of transmit antenna elements 210 and the particular transmit antenna elements 210 that make up the subset in order to reduce the FOV to a field include the estimated location of the target 20. The M 215 transmit antenna elements 210 may be selected using known statistical techniques such as an error minimization criteria (e.g., mean square error) to minimize error in estimating a parameter such as angular resolution, for example. The known error minimization technique may include estimating error as a distance from a global Baysian Cramer Rao Lower Bound (CRLB) of the direction of arrival (DOA) estimate. After each iteration or cycle in which M 215 transmit antenna elements 210 result in echoes, the DOA is estimated and a Fisher information matrix (of expected values) is obtained. The Fisher information is then used to estimate the distance from the CRLB, which provides an estimate of error. Processing received reflections to obtain a higher resolution location estimate for the target 20, at block 450, may be done iteratively with the process at block 440. The FOV may be reduced at each iteration, for example. The target 20 location obtained at block 450 may be provided (output 451) through a communications component of the array radar system 110. In the exemplary case of the platform 10 being a host vehicle 101, for example, the target 20 location may be provided to a collision avoidance system of the host vehicle 101 or central controller.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A method of performing cognitive transmission switching with an array radar system including N transmit antenna elements to determine a location of a target, the method comprising:
obtaining a crude estimation for the location of the target;
selecting M channels for transmission based on the crude estimation, wherein the M channels correspond with a subset of the N transmit antenna elements; and
processing reflections resulting from the M channels to determine the location of the target.

2. The method according to claim 1, wherein the obtaining the crude estimation is based on information from another sensor.

3. The method according to claim 1, wherein the obtaining the crude estimation is based on selecting L channels for transmission, the L channels corresponding with fewer than the N transmit antenna elements and the L channels being different than the M channels.

4. The method according to claim 3, wherein the selecting L channels for transmission is based on a uniform linear array configuration of the corresponding transmit antenna elements.

5. The method according to claim 3, wherein the selecting L channels is performed iteratively with a different selection or number of the L channels in each iteration to obtain the crude estimate.

6. The method according to claim 1, wherein the selecting the M channels is based on an error minimization criteria.

7. The method according to claim 1, further comprising receiving the reflections resulting from the M channels with one receive antenna.

8. The method according to claim 1, further comprising receiving the reflections resulting from the M channels with one or more receive antennas.

9. A cognitive transmission switching array radar system to determine a location of a target, the system comprising:
N transmit antenna elements arranged in an array; and
a processor configured to obtain a crude estimate for the location of the target, select M channels for transmission based on the crude estimation, the M channels corresponding with a subset of the N transmit antenna elements, and process reflections resulting from the M channels to determine the location of the target.

10. The system according to claim 9, wherein the processor obtains the crude estimate based on information from another sensor.

11. The system according to claim 9, wherein the processor selects L channels for transmission to obtain the crude estimate for the location of the target, the L channels corresponding with fewer than the N transmit antenna elements and the L channels being different than the M channels.

12. The system according to claim 11, wherein the processor selects the L channels based on a uniform linear array configuration of the corresponding transmit antenna elements.

13. The system according to claim 11, wherein the processor selects the L channels iteratively with a different selection or number of the L channels in each iteration to obtain the crude estimate.

14. The system according to claim 9, wherein the processor selects the M channels based on an error minimization criteria.

15. The system according to claim 9, further comprising one receive antenna to receive the reflections resulting from the M channels.

16. The system according to claim 9, further comprising an array of receive antennas configured to receive the reflections resulting from the M channels.
